(19) United States
(12) Patent Application Publication
(10) Pub. No.: US 2011/0296882 A1
(43) Pub. Date: Dec. 8, 2011

(54) Method for repairing a key and repaired key

(76) Inventors: John C. Parenti, West Hartford, CT (US); John S. Mierzejewski, West Hartford, CT (US)

(21) Appl. No.: 12/802,361

(22) Filed: Jun. 4, 2010

(51) Int. Cl. E05B 19/04; B23P 6/00

(52) U.S. Cl. 70/408; 29/402.01

(57) ABSTRACT

A method for repairing the head of a “chip key” comprising the steps of providing a section of polyolefin tubing, forming the tubing to a blank slightly larger than the key head with a grommet defining a key ring hole, and assembling the blank about the key head and heat shrinking the same into tight engagement with the key head.

### BACKGROUND OF THE INVENTION

Keys which carry an imbedded microchip or so called “chip keys” have become very popular with automobile manufacturers and with the purchasing public. The replacement of lost or broken “chip keys,” however, may be inconvenient and quite expensive, with dealers who may be the only source of supply commonly charging $100.00 to $200.00 or more per copy.

It is the general object of the present invention to provide a simple and inexpensive method for repairing keys and “chip keys” in particular, as well as an effective resulting repaired key.

### SUMMARY OF THE INVENTION

In fulfillment of the foregoing object and in accordance with the method of the present invention, the separate parts if any of the head of a key are assembled as nearly as possible in conformity with the original configuration of the head. A small section of heat shrinkable polyolefin tubing in then provided of a length approximately equal to the dimension of the key head measured from the junction at the bottom of the head with the key shank to the top of the key head. The key head is then inserte4d telescopically into the interior of the tubing section and the assembled key and tubing section are heated at a temperature between two (2) hundred and three (3) hundred degrees Fahrenheit until the tubing shrinks tightly about the key head and secures any separate parts thereof tightly together.

Preferably, the length of tubing is slightly longer than the measured dimension of the key head and the key head is positioned within the tubing section with the excess portion of the tubing extending slightly beyond the top of the head. Further, the excess portion of the tubing may be shaped to a generally V-shaped configuration with apex of the V remote from the key head. Still further, a small grommet with an opening approximating the size of a key ring hole is mounted in the excess portion of the tubing near the apex of the V.

Optionally, adhesive may be applied to the interior surface of the polyolefin tubing section.

Finally, the repaired key exhibits the characteristics of the method with a heat shrinkable tubing section tightly enveloping its head and a V shaped portion of the tubing projecting from the top of its head with a small grommet defining a key ring hole.

### BRIEF DESCRIPTION OF THE DRAWINGS

FIG. 1 is a plan view of a key with a fractured head in separate parts,

FIG. 2 is a perspective view of a section of polyolefin tubing,

FIG. 3 is a plan view of a shaped blank made from the tubing of FIG. 2, and

FIG. 4 is a plan view of a repaired key with the tubing section shrunk tightly about the key head.

### DESCRIPTION OF PREFERRED EMBODIMENT

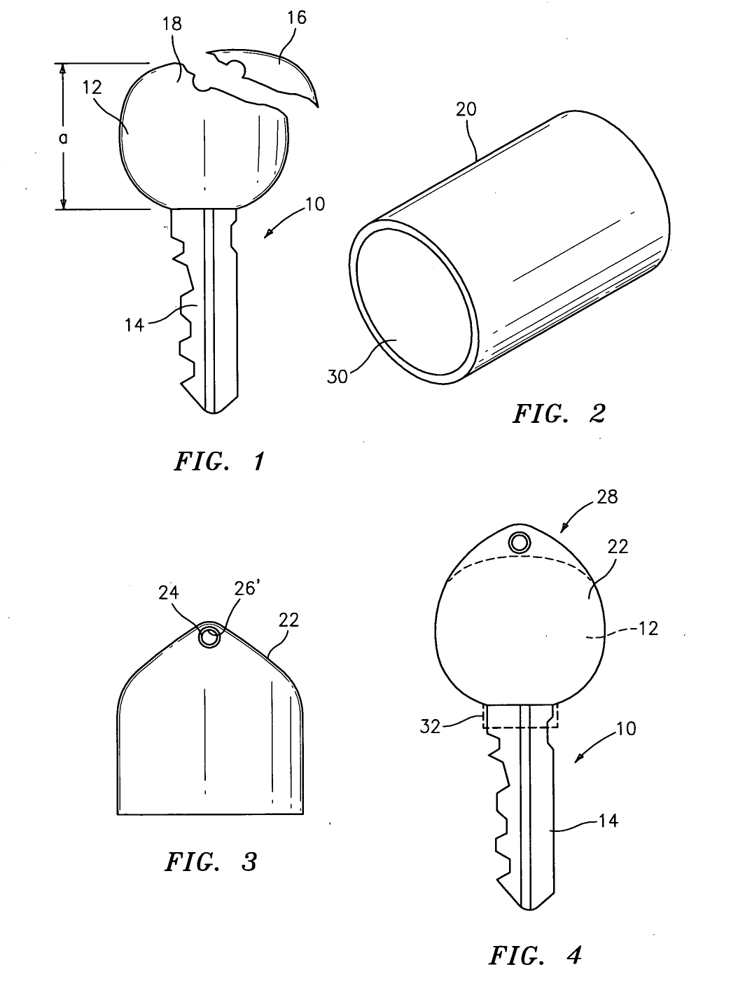

Referring particularly to FIG. 1, a key indicated generally at 10 has a head 12 and an integral shank 14, which carries a specific configuration or combination of peaks and valleys, which are complementary to those in the mating key hole which it is intended to fit. The head of the key is broken in what might be termed a severe compound fracture with two separate parts 16 and 18 resulting.

The key 10 is or may be of the “chip key” type, but it will be understood that the present invention is applicable to keys of any type. Also, the type of fracture shown can be repaired with the method of the present invention, but here again, it should be understood that various types of partial and more severe fractures can be repaired with the method of the present invention as well as fractures at the base of the head of the key where it joins the key shank 14. Such fractures at the base of the head can be accommodated by making the tube section 20 of FIG. 2 of sufficient length to extend a short distance downwardly along the shank (see broken line 32 in FIG. 4). In accordance with the method of present invention, the two parts 16 and 18 are first assembled in position resembling as closely as possible the original condition of the key head. Thereafter, a section of polyolefin tubing is provided of a length approximating the dimension “a” measured from the junction at the base of the key head with the key shank to the top of the key. Preferably, the section of tubing 20 is slightly in excess of this dimension and a blank 22 is formed therefrom as illustrated in FIG. 3. The blank 22 has a generally “V”-shaped portion at the top formed in the excess portion of the tubing 20 which extends beyond the top of the key head. Near the apex of the “V”-shaped portion, a small grommet 24 is provided and defines a key ring opening 26. The blank 22 is telescopically assembled with the head of the key 12 disposed within its interior and heat is then applied to the assembly to shrink the blank tightly about the head of the key as illustrated in the repaired key indicated generally at 28 in FIG. 4. Heat applied to the tubing blank 22 should be in the range of two to three hundred degrees Fahrenheit, and more specifically, in the neighborhood of 250 degrees Fahrenheit. A common hair dryer can be employed in the home for this purpose.

When the blank 22 is shrunk about the key head and in tight engagement with the head, the repaired key may be employed in precisely the same manner as an original key without fear of disengagement of the tubing or other problems. In this regard, it should be noted that the tubing section 20 may be provided with a coating of adhesive on its interior surface for enhanced bonding with the key head and enhanced integrity of the repaired key.

The repaired key exhibits the characteristics of the aforedescribed method having a blank formed from a section of polyolefin tubing assembled thereabout and thereafter heated and shrunk into tight engagement with the head of the key 10.

In view of the foregoing, it will be apparent that a “chip key,” or the like can be repaired in the practice of the method of the present invention for a mere fraction of the cost of a replacement key and can be used thereafter in the same manner as an expensive replacement key.

1. A method for repairing the head of a key comprising the steps of assembling the parts of the head if separated as nearly as possible to the original configuration of the head, providing a small section of heat shrinkable polyolefin tubing having a length approximately equal to the dimension of the head measured from the junction of the shank of the key with the bottom of the head to the top of the head, inserting the key head telescopically into the interior of the tubing section, and heat shrinking the tubing section at a temperature between two (2) and three (3) hundred degrees Fahrenheit until the tubing shrinks tightly about the key head and secures any separate parts thereof tightly together.

2. A method for repairing the head of a key as set forth in claim 1 wherein the section of heat shrinkable polyolefin tubing is dimensioned slightly longer than the measured dimension of the head, and wherein the key is positioned within the tubing section with the excess portion of the tubing extending slightly beyond the top of the head.

3. A method for repairing the head of a key as set forth in claim 2 wherein the excess portion of the tubing is shaped to a generally V-shaped configuration with the apex of the V remote from the key head.

4. A method for repairing the head of a key as set forth in claim 3 wherein a small grommet with an opening approximating the size of the original key ring hole is mounted in the excess portion of the tubing near the apex of the V.

5. A method for repairing the head of a key as set forth in claim 1 wherein a coating of adhesive in applied to the interior surface of the polyolefin tubing prior to assembly with the key head.

6. A method for repairing the head of a key as set forth in claim 1 wherein heat is applied to the assembled key and tubing section at a temperature in the neighborhood of two hundred and fifty (250) degrees Fahrenheit.

7. A repaired key head comprising an original key head with parts assembled in their original configuration and a section of heat shrinkable tubing subsequent to the application of heat tightly enveloping the assembled parts.

8. A repaired key head as set forth in claim 7 wherein said tubing has an excess portion in a generally V configuration projecting from the top of the key head.

9. A repaired key head as set forth in claim 8 wherein said tubing has a small grommet with an opening the size of the original key ring hole mounted near the apex of the V shaped excess portion.

10. A repaired key head as set forth in claim 7 wherein said tubing and said key head are adhesively bonded together.
